(19) United States
(12) Patent Application Publication
(10) Pub. No.: US 2017/0250847 A1
(43) Pub. Date: Aug. 31, 2017

(54) PARALLEL TRANSMISSION OF HIGH EFFICIENCY SIGNAL FIELD

(71) Applicant: INTEL CORPORATION, Santa Clara, CA (US)

(72) Inventors: Qinghua LI, San Ramon, CA (US); Xiaogang CHEN, Beijing (CN); Huaning NIU, Milpitas, CA (US); Robert J. Stacey, Portland, OR (US); Yuan ZHU, Beijing (CN); Hujun YIN, Saratoga, CA (US)

(73) Assignee: INTEL CORPORATION, Santa Clara, CA (US)

(21) Appl. No.: 15/509,781

(22) PCT Filed: Sep. 30, 2015
(86) PCT No.: PCT/US15/53278

§ 371 Date: Mar. 8, 2017

Related U.S. Application Data
(60) Provisional application No. 62/061,073, filed on Oct. 7, 2014.

(51) Int. Cl. H04L 27/26; H04B 7/0452; H04B 7/26; H04L 29/06

(52) U.S. Cl. CPC H04L 27/2613; H04L 69/22; H04B 7/0452; H04B 7/2621; H04B 1/38

(57) ABSTRACT

This disclosure describes systems, and methods related to parallel transmission of high efficiency SIGNAL field in communication networks. A device may generate a high efficiency preamble in accordance with a high efficiency communication standard, the high efficiency preamble including, at least in part, one or more legacy SIGNAL fields, one or more high efficiency SIGNAL fields, and one or more channel training fields. The device may cause to send the one or more channel training fields to one or more first devices. The device may determine one or more spatial channel streams associated with at least one of the one or more first devices, the one or more spatial channel streams includes a first stream and a second stream. The device may partition the at least one of the one or more high efficiency SIGNAL fields into, at least in part, a common part and one or more user-specific parts, the one or more user-specific parts includes a first user-specific part and a second user-specific part. The device may cause to send at least one of the one or more user-specific parts using the one or more spatial channel streams.

### CROSS-REFERENCE TO RELATED APPLICATIONS

This application claims the benefit of U.S. Provisional Application No. 62/061,073 filed Oct. 7, 2014 the disclosure of which is incorporated herein by reference as if set forth in full.

### TECHNICAL FIELD

This disclosure generally relates to systems and methods for wireless communications and, more particularly, to parallel transmission of high efficiency SIGNAL field in multi-user multiple-input multiple-output antenna in a wireless communication network.

### BACKGROUND

Wi-Fi network performance is an important factor in environments with high numbers of users, such as hotspots in public venues. Efficient use of available spectrum and better management of interferences in a Wi-Fi environment may improve Wi-Fi performance. In order to address the issue of increasing bandwidth requirements that are demanded for wireless communications systems, different schemes may be employed to allow multiple user devices to communicate with a single access point by sharing the channel resources while achieving high data throughputs. Multiple Input or Multiple Output (MIMO) technology represents one such scheme that has recently emerged as a popular technique for the next generation communication systems. MIMO technology has been adopted in several emerging wireless communications standards such as the Institute of Electrical and Electronics Engineers (IEEE) 802.11 standard.

### BRIEF DESCRIPTION OF THE DRAWINGS

FIG. 1 depicts a network diagram illustrating an example network environment of an illustrative parallel transmission of high efficiency SIGNAL field system, in accordance with one or more example embodiments of the disclosure.

FIG. 2 depicts an illustrative schematic diagram of a parallel transmission of high efficiency SIGNAL field system, in accordance with one or more embodiments of the disclosure.

FIG. 3 depicts an illustrative schematic diagram of a parallel transmission of high efficiency SIGNAL field system, in accordance with one or more embodiments of the disclosure.

FIG. 4 depicts an illustrative schematic diagram of a parallel transmission of high efficiency SIGNAL field system, in accordance with one or more embodiments of the disclosure.

FIG. 5 depicts a flow diagram of an illustrative process for a parallel transmission of high efficiency SIGNAL field system, in accordance with one or more embodiments of the disclosure.

FIG. 6 illustrates a functional diagram of an example communication station that may be suitable for use as a user device, in accordance with one or more example embodiments of the disclosure.

FIG. 7 is a block diagram of an example machine upon which any of one or more techniques (e.g., methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A multi-user multiple-input multiple-output antenna system (MU-MIMO) may provide an enhancement for the IEEE 802.11 family of standards. With MU-MIMO, multiple user devices may be served at the same time by one or more access points (APs). Some of the IEEE 802.11 standards (e.g., IEEE 802.11ax) may use orthogonal frequency division multiplexing access (OFDMA) to boost the amount of data an AP may transmit. Like OFDM (orthogonal frequency-division multiplexing), OFDMA encodes data on multiple sub-carrier frequencies—essentially packing more data into the same amount of air space. It is understood that OFDMA is a multi-user version of OFDM digital modulation scheme. Multiple access is achieved in OFDMA by assigning subsets of subcarriers to individual user devices, which may allow simultaneous data rate transmission from several user devices.

The physical layer header (PHY header) may include one or more fields known as SIGNAL or SIG fields. A SIGNAL field may be sequentially transmitted using a single spatial stream for the downlink multiuser MIMO, which may result in an inefficient transmission as each SIGNAL field is sent sequentially for multiple user streams. The SIGNAL payload is typically between 20-50 bits per user device, which may include 9-14 bit user ID, 7 bit Modulation and Coding Scheme (MCS), and 6-12 bit resource allocation index. Each 20 MHz sub-channel may have up to 36 users who may be distributed over 8 spatial streams and 9 subbands or resource units (RUs). It may take more than 100 μs for sending the SIGNAL for 36 user devices. This overhead is about 10% of a 1 ms packet.

One or more example embodiments discussed herein relate to systems, methods, and devices for parallel transmission of a high efficiency SIGNAL field using MIMO capabilities. A SIGNAL field may be transmitted in parallel over multiple spatial streams of a downlink MU-MIMO. For example, the SIGNAL field may be partitioned into two parts, a common part and a user-specific part. The common part is part of the SIGNAL field that may be common to one or more user devices serviced by an AP. The common part may be broadcasted to one or more users using a single stream. However, the user-specific part of the SIGNAL field may be sent using multiple spatial streams of a downlink MU-MIMO. It is understood that although the user-specific part is sent using multiple spatial streams, the user-specific part may be also sent using single stream broadcasting. Transmitting the user-specific parts using multiple spatial streams may reduce the transmission time of the user-specific parts by M times, where M is the number of spatial streams.

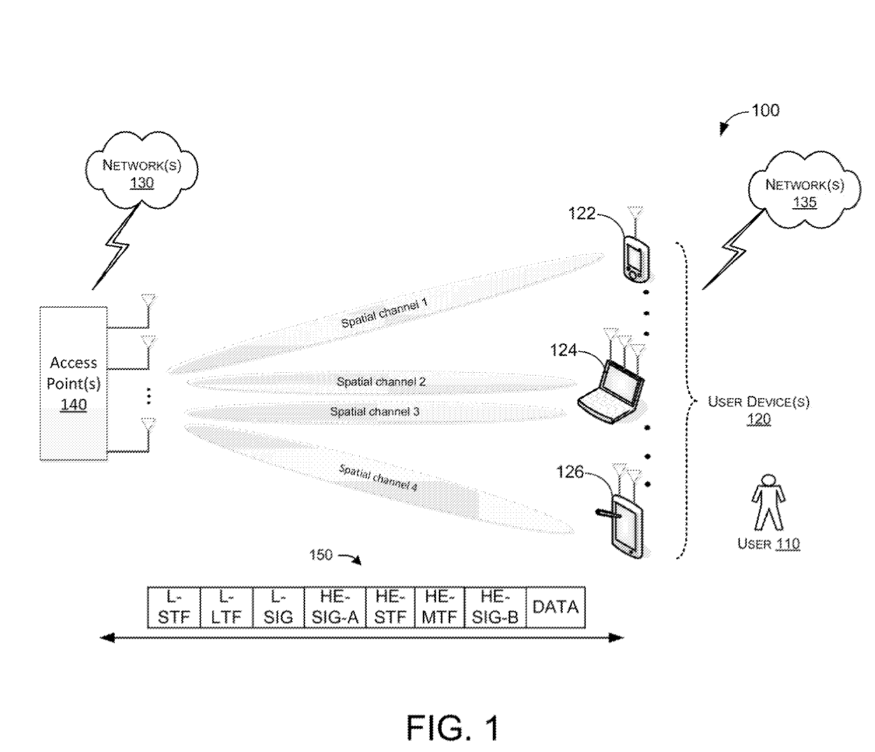

FIG. 1 is a network diagram illustrating an example network environment, according to some example embodiments of the present disclosure. Wireless network 100 can include one or more user devices 120 and one or more access point(s) (AP) 140, which may communicate in accordance with IEEE 802.11 communication standards, including IEEE 802.11ax (HEW). The user device(s) 120 may be mobile devices that are non-stationary and do not have fixed locations.

The one or more illustrative user device(s) 120 may be operable by one or more users (e.g., user(s) 110), as depicted in FIG. 1. The user device(s) 120 (e.g., user devices 122, 124, and 126) may include any suitable processor-driven user device including, but not limited to, a desktop computing device, a laptop computing device, a server, a router, a switch, a smartphone, a tablet, wearable wireless device (e.g., bracelet, watch, glasses, ring, etc.) and so forth.

Any of the user device(s) 120 (e.g., user devices 122, 124, and 126) and AP(s) 140 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The user device(s) 120 may communicate with one or more APs 140. The AP(s) 140 may be configured to provide access to one or more wireless networks. The AP(s) 140 may provide wireless signal coverage for a predefined area. The user device 120 may communicate with the AP(s) 140 wirelessly or through one or more network(s) 130. The AP(s) 140 may be a wireless AP, a router, a server, another mobile device, or any device that may wirelessly communicate with the user device 120 to provide the user device 120 access to a network, such as the Internet.

Any of user device(s) 120 and AP(s) 140 may include one or more communications antennae. Communications antenna may be any suitable type of antenna corresponding to the communications protocols used by the user device(s) 120 and AP(s) 140. Some non-limiting examples of suitable communications antennas include Wi-Fi antennas, IEEE 802.11 family of standards compatible antennas, directional antennas, non-directional antennas, dipole antennas, folded dipole antennas, patch antennas, MIMO antennas, or the like. The communications antenna may be communicatively coupled to a radio component to transmit and/or receive signals, such as communications signals to and/or from the user devices(s) 120. Any of the user device(s) (e.g., user device(s) 120 and 150) and AP(s) 140, may include any suitable radio and/or transceiver for transmitting and/or receiving radio frequency (RF) signals in the bandwidth and/or channels corresponding to the communications protocols utilized by any of the user device(s) 120 and AP(s) 140 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad) or any other 802.11 type channels (e.g., 802.11ax). In some embodiments, non-Wi-Fi protocols may be used for communications between devices, such as Bluetooth, dedicated short-range communication (DSRC), Ultra-High Frequency (UHF), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 140) establishes communication with one or more user devices 120 (e.g., user devices 124, 126, and/or 128), the AP may communicate in the downlink direction by sending data packets. The communication may be established using one or more data streams, also referred to as communication streams or communication channels. The data packets may be preceded by one or more preambles that may be part of one or more headers. These preambles may be used to allow the user device to detect a new incoming data packet from the AP. A preamble may contain one or more fields used to synchronize transmission timing between two or more devices (e.g., between the APs and user devices).

In one embodiment, and with reference to FIG. 1, an HEW data packet (e.g., data packet 150) may include at least in part, a legacy short training (L-STF) field, a legacy long training (L-LTF) field, a legacy SIGNAL (L-SIG) field, a high efficiency SIGNAL field A (HE-SIG-A), a high efficiency short training (HE-STF) field, a high-efficiency multi-user training (HE-MTF) field, a high efficiency SIGNAL field B (HE-SIG-B), and a data field that contains the data to be transmitted from the transmitting device (e.g., AP 140) to a receiving device (e.g., user devices 124, 126 and/or 128).

In the example of FIG. 1, three user devices (e.g., user devices 122, 124 and 126) may be scheduled to transmit and receive data in a frequency band (e.g., 20 MHz band). Utilizing the IEEE 802.11ax standard as an example, the user device 126 may be served in a frequency sub-band different from that used for user device 122 and user device 124. The user device 122 and the user device 124 may be served in the same frequency sub-band by the AP 140 in the downlink direction. Assuming in this example that user device 122 establishes one data stream (e.g., spatial channel 1) between it and the AP 140, the user device 124 establishes two data streams (e.g., shown as spatial channels 2 and 3) between it and the AP 140, and the user device 126 establishes one data stream (e.g., spatial channel 4) between it and the AP 140. The AP 140 may form four data streams (in the form of spatial channels), one for the user device 122, two for the user device 124 and one for the user device 126.

In some embodiments, parallel training system 100 may facilitate the transmission of a high efficiency SIGNAL field in parallel over multiple spatial streams of a downlink MU-MIMO. For example, the high efficiency SIGNAL field may be partitioned into two parts, a common part and a user-specific part. The common part is part may be common to one or more user devices serviced by an AP. The common part may be broadcasted to one or more users using a single stream. However, the user-specific part of the SIGNAL field may be sent using multiple spatial streams of a downlink MU-MIMO.

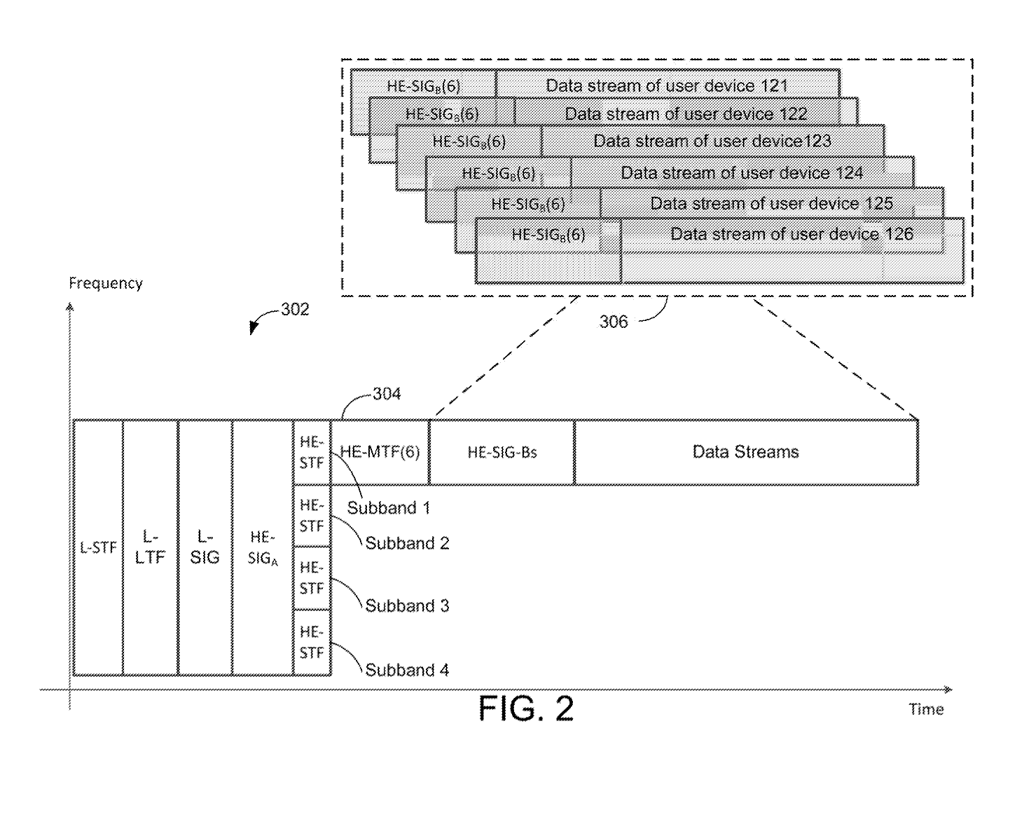

Referring to FIG. 2, an example illustrative embodiment of a parallel transmission of high efficiency SIGNAL field system in accordance to an embodiment of the disclosure is provided.

As may be seen in FIG. 2, the preamble 302 may contain various fields that may be defined in one or more wireless standards such as IEEE 802.11 family of standards.

The HE-SIG-A may stand for high efficiency SIGNAL field A. It may provide the common information for the band, such as, the subband partitions of the band and the total number of streams per subband. It should be noted that the partitioned subbands may not have the same sizes. Further, some user-specific information may be also included in the HE-SIG-A.

The HE-STF field denotes high efficiency short training field, which may enable the receiver (e.g., the user device(s) 120) to set the automatic gain control (AGC) properly to a suitable gain level for the subsequent signals that may be beamformed. After the HE-STF, channel training signals for the spatial channels may be sent.

The HE-MTF may stand for high efficiency multiplexed training field. The HE-MTF may contain signals for the channel training of the spatial streams in the subband. The HE-MTF may be subband specific. For example, if one subband has more spatial streams than the other subband, the HE-MTF may have a longer duration than that of the other subband.

In one embodiment, the channel training overhead may be reduced by combining the training signals of different streams by frequency domain downsampling. For example, the channel training of two beamformed spatial streams may be tone interleaved. Even tones of the OFDMA symbol may be assigned to one stream's training signals and the odd tones may be assigned to the other streams. Channel interpolation may be applied in the channel estimation for obtaining the channel responses of all tones in the allocated subband. For the example in FIG. 2, the 20 MHz band is partitioned into four subbands (e.g., subbands 1, 2, 3, and 4). In this example, the first subband has 5 MHz bandwidth. In this example, there may be six spatial streams (e.g., data streams 306) in the subband 1 for one or more user devices (e.g., user devices 121, 122, 123, 124, 125, and 126 from FIG. 1). There may be six user-specific parts (e.g., HE-SIG-B) sent one each of the six spatial streams.

L-SIG and L-LTF may stand for legacy SIGNAL field and legacy long training field, respectively. The legacy parts may be needed for mixed mode operation with IEEE 802.11a/n/ac/ax devices. The format of HE-MTF may be specified by the HE-SIG-A.

The HE-SIG-B may stand for high efficiency SIGNAL field B. It may contain the user device specific information. For example, it may specify the MCS of the addressed user device and the user's ID or part of the ID. In addition, it may specify the indexes of the user device's spatial streams so that the user device may find the training signals for its streams and training signals for the other interfering streams within the MTF. Since the channel state information (CSI) may be already learned from the MTF, precisely or roughly, there may be no need for additional channel training in or after the HE-SIG-B symbol.

Since IEEE 802.11ax is designed to support more than 100 users per cell, the 6-bit group ID of IEEE 802.11ac may not provide flexible scheduling. Increasing the group ID size may be difficult since it may incur high complexity in the user device table lookup. Therefore, user ID or partial user ID may be needed for the scheduling. The partial user ID is known as partial access ID (PAID), which is in the range of 6-11 bits making it one of the major SIGNAL payloads. Another major payload is the resource allocation index. The resource allocation index may indicate which spatial stream and subband has the user device's data. This resource allocation index usually occupies about 6-12 bits per user device.

In one embodiment, all or part of the user IDs may be sent in parallel in HE-SIG-B for reducing transmission time. In addition, the allocation index may be omitted by putting the user ID on the resource allocation directly. If the user device finds its ID on the stream and subband in the HE-SIG-B symbol, then the user device has the data there in the subsequent data portion. Therefore, there the allocation index may be omitted.

In FIG. 2, the number of HE-SIG-B equals the total number of streams in the subband. For example, there are six streams in the subband 1 and therefore, there are six HE-SIG-B sent in parallel after the HE-MTF. If each of the streams is for a different user device, the beamforming and contents of the HE-SIG-B are all different.

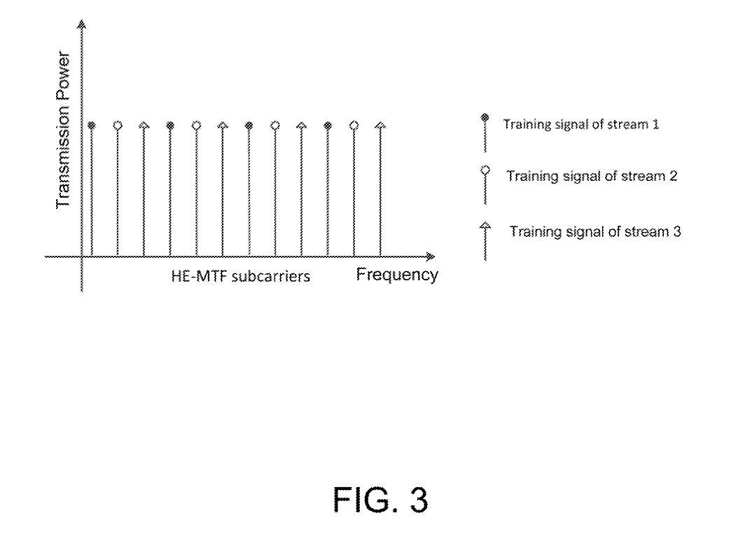

Referring to FIG. 3, an example illustrative embodiment of a multi-user training field (MTF) in Frequency Division Multiplexing (FDM) format in shown in accordance with one embodiment of the disclosure is provided.

The training signals for the streams in the subband may share the subband using time division multiplexing (TDM), frequency division multiplexing (FDM), or code division multiplexing (CDM) techniques or combination thereof CDM (together with TDM) is used in legacy 802.11ac for downlink MIMO, where the number of MTF symbols is equal to or greater than the total number of streams. FDM may be used for IEEE 802.11ax. For FDM, the number of MTF (e.g., HE-MTF) symbols may be smaller than the total number of streams. This may reduce the training overhead.

In one embodiment, the AP(s) 140 may generate the additional field (HE-MTF) to contain training signals of M streams that may be condensed into N symbol in FDM fashion, where M>N (e.g., M=2 and N=1). During reception, the receiver of the HE-MTF field (e.g., user devices 122 and/or 124) may know where the desired signal and interference signal are located in the MTF (e.g., HE-MTF) from the physical layer header e.g. HE-SIG-A or the control channel CCH. Frequency domain interpolation may be used to obtain the interference statistics e.g. covariance matrix for each subcarrier in the allocated subband. After the interference statistics are obtained, interference mitigation techniques, such as a minimum mean square error estimation (MMSE) receiver, may be used for mitigating the residual crosstalk. For example, assuming M=2 and N=1, every even subcarrier may carry the training signal for stream 1 and every odd subcarrier may carry the training signal for stream 2. For a second example, M=3 and N=1. Subcarriers 1, 4, 7, . . . 3n+1 carry the training signals for stream 1; subcarriers 2, 5, 8, . . . 3n+2 carry the training signals for stream 2; and subcarriers 3, 6, 9, . . . 3n+3 carry the training signals for stream 3. For a third example, M=8, N=2. Every 8th subcarrier is for a stream in both symbols e.g. subcarriers 1, 9, 17, for stream 1, subcarriers 2, 10, 18 for stream 2, and so forth. It is understood that the above are only example of various values for M and N and that other values and combinations may be utilized.

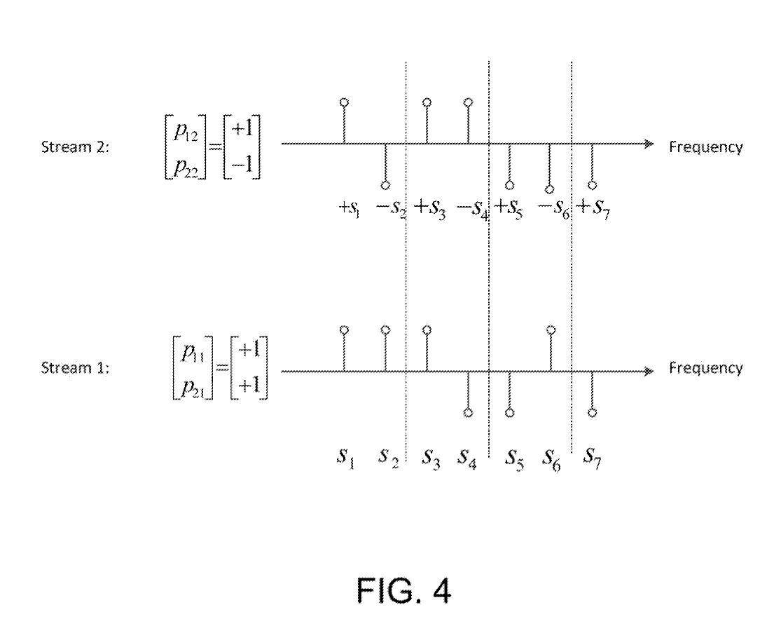

FIG. 4 shows an illustrative embodiment of a parallel transmission of high efficiency SIGNAL field system in accordance to an embodiment of the disclosure.

In one embodiment, and HE-SIG-B transmission scheme enabling data-aided channel estimation may be utilized. For example, if a user device has multiple streams, the streams may carry orthogonal sequences as illustrated in FIG. 4. In an example, the user device may have two streams (Stream 1 and Stream 2). The Stream 1 may be the stream with the least index that may carry the HE-SIG-B. The user device may be able to decode the Stream 1 reliably because the HE-SIG-B may have a relatively higher decoding rate than the corresponding data portion on the same stream. Therefore, there may be no need for the other stream of the same user device to carry the same information. Since the major interference in MU-MIMO is the inter-stream interference among the same user device's streams, it may be desirable to enhance the channel training for mitigating inter-stream interference from the same user device or from a different user device. Instead of sending the same HE-SIG-B again, sequences orthogonal to the HE-SIG-B sequence may be sent on the other streams. For example, Stream 1 may carry the HE-SIG-B data symbols s1, s2, . . . , s7 across frequency tones within the HE-SIG-B OFDM (or OFDMA) symbol, while Stream 2 may carry sequences orthogonal to the HE-SIG-B sequence. Further, streams from other user devices may also carry sequences orthogonal to the HE-SIG-B sequence. Alternatively, orthogonal sequences may be masked with the HE-SIG-B sequence. The masked HE-SIG-B sequences may be sent by the streams, respectively.

Generally, a P matrix is a complex or real square matrix with every principle minor>0. A minor of a matrix A is generally a determinant of some smaller square matrix, cut down from A by removing one or more of its rows or columns. Minors obtained by removing just one row and one column from square matrices (first minors) are required for calculating matrix cofactors, which in turn are useful for computing both the determinant and inverse of square matrices. An orthogonal matrix such as the P matrix may be applied to the training symbols for a given group of user devices, which may result in training symbols being separated and more easily distinguishable from one to another. An orthogonal matrix such as the sub-matrix of the P matrix of IEEE 802.11ac, whose size is M elements by N elements, where M≦N, may be selected. For example, interferences between the symbols may be mitigated by utilizing the orthogonality feature of the training symbol sequences that have been converted using a P matrix.

In another embodiment, the user device may have N streams. An orthogonal matrix such as the P matrix of IEEE 802.11ac, whose size is M by M, M≧N may be selected. The consecutive tones may be divided into groups of M tones as is done in FIG. 4 where M=2. The transmitted symbols for a given group may be given by:

$$[ \begin{matrix}{x}_{i + 1} ( 1 ) & & {x}_{i + 1} ( N ) \\ ⋮ & … & ⋮ \\ {x}_{i + M} ( 1 ) & & {x}_{i + M} ( N )\end{matrix} ] = [ \begin{matrix}{s}_{i + 1} & & \\ & ⋱ & \\ & & {s}_{i + M}\end{matrix} ] [ \begin{matrix}{p}_{11} & & {p}_{1 N} \\ ⋮ & … & ⋮ \\ {p}_{M 1} & & {p}_{MN}\end{matrix} ] ,$$

Where

$$[ \begin{matrix}{p}_{11} & & {p}_{1 N} \\ ⋮ & … & ⋮ \\ {p}_{M 1} & & {p}_{MN}\end{matrix} ]$$

has (the first) N columns of the orthogonal matrix; sᵢ₊₁, . . . , S_{i+M} are HE-SIG-B data symbols in a group of M tones; the N columns of

$$[ \begin{matrix}{x}_{i + 1} ( 1 ) & & {x}_{i + 1} ( N ) \\ ⋮ & … & ⋮ \\ {x}_{i + M} ( 1 ) & & {x}_{i + M} ( N )\end{matrix} ]$$

are the masked, transmitted symbols respectively for the N streams over the M tones of the group. This may be similar to the orthogonal space-time codes except space-frequency domain may be used instead of space-time domain. The decoding process may be implemented as is shown below. The received signals on the streams can be written as:

$$[ \begin{matrix}{r}_{i + 1} ( 1 ) & & {r}_{i + 1} ( N ) \\ ⋮ & … & ⋮ \\ {r}_{i + M} ( 1 ) & & {r}_{i + M} ( N )\end{matrix} ] = [ \begin{matrix}{s}_{i + 1} & & \\ & ⋱ & \\ & & {s}_{i + M}\end{matrix} ] [ \begin{matrix}{p}_{11} & & {p}_{1 N} \\ ⋮ & … & ⋮ \\ {p}_{M 1} & & {p}_{MN}\end{matrix} ] H + Ψ ,$$

Where H is the channel matrix under estimation; ψ is the noise plus inter-user interference matrix. For lowering the estimation complexity, it may be assumed that the channel remains constant across the M tones. A linear solution of H in the equation above may be easily obtained from MMSE or zero-forcing filter, for example:

$$\hat{H} = {{[ \begin{matrix}{p}_{11} & & {p}_{1 N} \\ ⋮ & … & ⋮ \\ {p}_{M 1} & & {p}_{MN}\end{matrix} ]}^{H} [ \begin{matrix}{s}_{i + 1} & & \\ & ⋱ & \\ & & {s}_{i + M}\end{matrix} ]}^{H} [ \begin{matrix}{r}_{i + 1} ( 1 ) & & {r}_{i + 1} ( N ) \\ ⋮ & … & ⋮ \\ {r}_{i + M} ( 1 ) & & {r}_{i + M} ( N )\end{matrix} ] .$$

The estimate of H is combined with the estimate obtained from LTF or MTF for enhancing the channel estimation needed for the subsequent data portion.

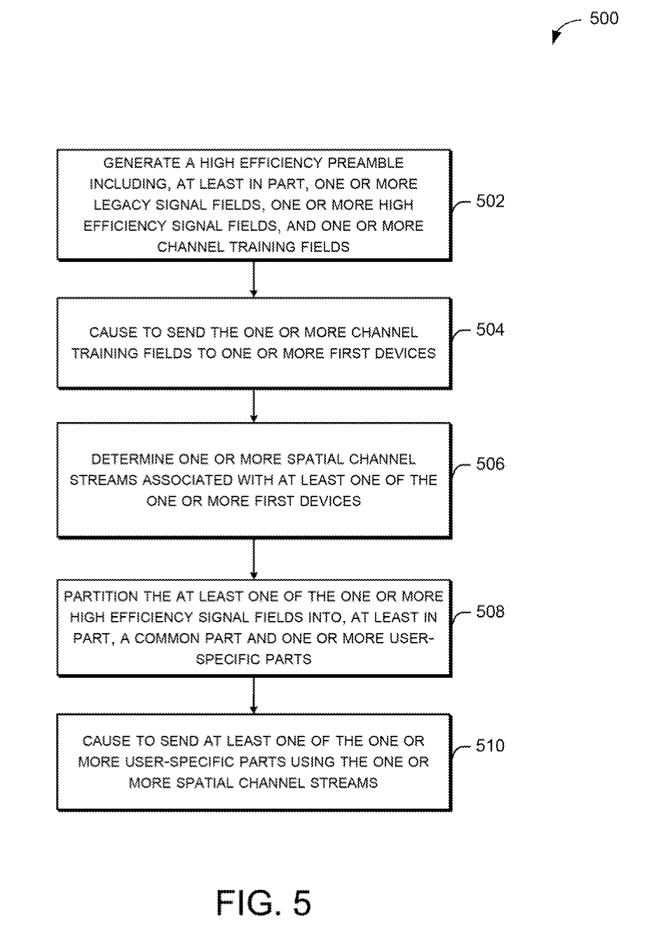

FIG. 5 illustrates a flow diagram of illustrative process 700 for a parallel transmission of high efficiency SIGNAL field system in accordance with one or more embodiments of the disclosure.

At block 502, an AP may generate a high efficiency preamble in accordance with a high efficiency communication standard, the high efficiency preamble including, at least in part, one or more legacy SIGNAL fields, one or more high efficiency SIGNAL fields, and one or more channel training fields. The preamble may be used for channel training in a multi-user multiple-input and multiple-output (MU-MIMO) system, where and other devices may have one or more antennas in order to be able to utilize the functions of the MU-MIMO. The one or more high efficiency SIGNAL fields include at least one of a high efficiency SIGNAL A (HE-SIG-A) field and a high efficiency SIGNAL B (HE-SIG-B) field. The one or more channel training fields may include at least in part, a legacy short training (L-STF) field, a legacy long training (L-LTF) field, and a high-efficiency multi-user training (HE-MTF) field.

At block 504, an AP may cause to send the one or more channel training fields to one or more first devices. For example, the AP may send the HE-MTF that may contain signals for the channel training of the spatial streams in the subband. That is the HE-MTF may be subband specific. For example, if one subband has more spatial streams than the other subband, the HE-MTF may have a longer duration than that of the other subband. The format of HE-MTF may be specified by the HE-SIG-A. The HE-MTF may be sent by the AP using one or more transmission techniques, for example, frequency division multiplexing (FDM).

At block 506, an AP may determine one or more spatial channel streams associated with at least one of the one or more first devices, the one or more spatial channel streams includes a first stream and a second stream. For example, there may be a number of spatial streams associated with one or more user devices.

At block 508, an AP may partition the at least one of the one or more high efficiency SIGNAL fields into, at least in part, a common part and one or more user-specific parts, the one or more user-specific parts includes a first user-specific part and a second user-specific part. The HE-SIG-B may contain the user device specific information. The HE-SIG-A may provide the common information for the band, such as, the subband partitions of the band and the total number of streams per subband. It should be noted that the partitioned subbands may not have the same sizes. Further, some user-specific information may be also included in the HE-SIG-A.

At block 510, an AP may cause to send at least one of the one or more user-specific parts using the one or more spatial channel streams. For example, the AP may send the user-specific parts (e.g., HE-SIG-B) using each streams established with the one or more user devices.

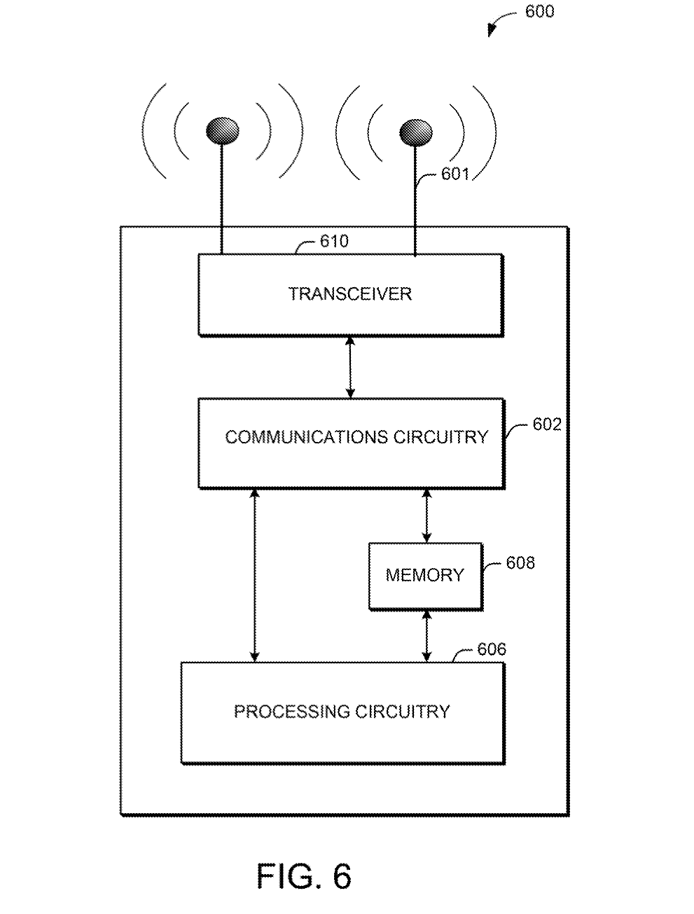

FIG. 6 shows a functional diagram of an exemplary communication station 600 in accordance with some embodiments. In one embodiment, FIG. 6 illustrates a functional block diagram of a communication station that may be suitable for use as an AP 140 (FIG. 1) or communication station user device 120 (FIG. 1) in accordance with some embodiments. The communication station 600 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2-5.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device may, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc. In some embodiments, the communication station 600 may include one or more processors and may be configured with instructions stored on a computer-readable storage device memory.

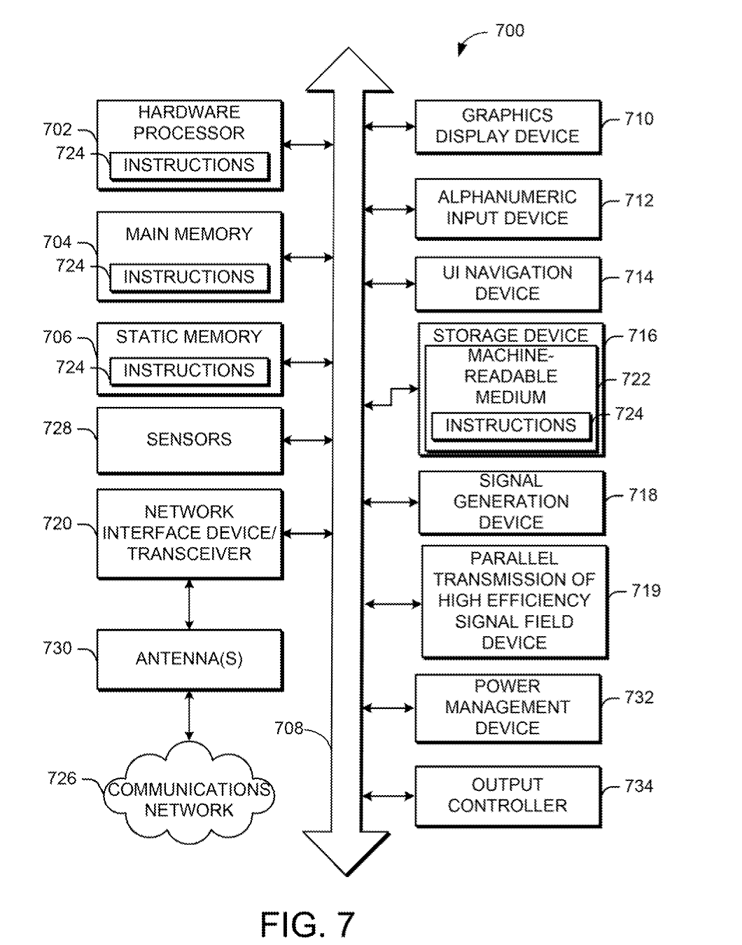

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a parallel transmission of high efficiency SIGNAL field device 719, a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The parallel transmission of high efficiency SIGNAL field device 719 may be carry out or perform any of the operations and processes (e.g., processes 400 and 500) described and shown above. For example, the parallel transmission of high efficiency SIGNAL field device 719 may be configured to permit parallel transmission of a SIGNAL field using MIMO capabilities. A SIGNAL field may be transmitted in parallel over multiple spatial streams of a downlink MU-MIMO. For example, the SIGNAL field may be partitioned into two parts, a common part and a user-specific part. The common part is part of the SIGNAL field that may be common to one or more user devices serviced by an AP. The common part may be broadcasted to one or more users using a single stream. However, the user-specific part of the SIGNAL field may be sent using multiple spatial streams of a downlink MU-MIMO. It is understood that although the user-specific part is sent using multiple spatial streams, the user-specific part may be sent using single stream broadcasting.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 400 and 500) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

According to example embodiments of the disclosure, there may be a device. The device may include at least one memory that stores computer-executable instructions, and at least one processor of the one or more processors configured to access the at least one memory, wherein the at least one processor of the one or more processors is configured to execute the computer-executable instructions to generate a high efficiency preamble in accordance with a high efficiency communication standard, the high efficiency preamble including, at least in part, one or more legacy SIGNAL fields, one or more high efficiency SIGNAL fields, and one or more channel training fields. The at least one processor of the one or more processors may be configured to execute the computer-executable instructions to cause to send the one or more channel training fields to one or more first devices. The at least one processor of the one or more processors may be configured to execute the computer-executable instructions to determine one or more spatial channel streams associated with at least one of the one or more first devices, the one or more spatial channel streams may include a first stream and a second stream. The at least one processor of the one or more processors may be configured to execute the computer-executable instructions to partition the at least one of the one or more high efficiency SIGNAL fields into, at least in part, a common part and one or more user-specific parts, the one or more user-specific parts may include a first user-specific part and a second user-specific part. The at least one processor of the one or more processors may be configured to execute the computer-executable instructions to cause to send at least one of the one or more user-specific parts using the one or more spatial channel streams.

The implementations may include one or more of the following features. The one or more high efficiency SIGNAL fields include at least one of a high efficiency SIGNAL A (HE-SIG-A) field and a high efficiency SIGNAL B (HE-SIG-B) field. The first user-specific part is sent using the first stream and the second user-specific part is sent using the second stream. the at least one processor of the one or more processors is further configured to execute the computer-executable instructions to determine one or more multi-user training fields (HE-MTF) associated with the one or more channel training fields. The device may be an access point operating in multi-user multi-input and multi-output (MU-MIMO) wireless communication. the at least one processor of the one or more processors is further configured to execute the computer-executable instructions to transmit, by the first computing device, a high efficiency multiplexed training field (HE-MTF) using the one or more spatial channel streams. The at least one processor of the one or more processors is further configured to execute the computer-executable instructions to transmit, by the first computing device, the HE-MTF using frequency division multiplexing (FDM) format. The one or more user-specific parts are user information elements (IEs) associated with the one or more first devices. The device may further include a transceiver configured to transmit and receive wireless signals. The device may further include an antenna coupled to the transceiver. The device may further include and one or more processors in communication with the transceiver.

According to example embodiments of the disclosure, there may be a non-transitory computer-readable medium storing computer-executable instructions which, when executed by a processor, cause the processor to perform operations. The operations may include generating a high efficiency preamble in accordance with a high efficiency communication standard, the high efficiency preamble including, at least in part, one or more legacy SIGNAL fields, one or more high efficiency SIGNAL fields, and one or more channel training fields. The operations may include causing to send the one or more channel training fields to one or more first devices. The operations may include determining one or more spatial channel streams associated with at least one of the one or more first devices, the one or more spatial channel streams may include a first stream and a second stream. The operations may include partitioning the at least one of the one or more high efficiency SIGNAL fields into, at least in part, a common part and one or more user-specific parts, the one or more user-specific parts include a first user-specific part and a second user-specific part. The operations may include causing to send at least one of the one or more user-specific parts using the one or more spatial channel streams.

Implementations may include one or more of the following features. The one or more high efficiency SIGNAL fields include at least one of a high efficiency SIGNAL A (HE-SIG-A) field and a high efficiency SIGNAL B (HE-SIG-B) field. The first user-specific part is sent using the first stream and the second user-specific part is sent using the second stream. The at least one processor of the one or more processors is further configured to execute the computer-executable instructions to determine one or more multi-user training fields (HE-MTF) associated with the one or more channel training fields. The device may be an access point operating in multi-user multi-input and multi-output (MU-MIMO) wireless communication. the at least one processor of the one or more processors is further configured to execute the computer-executable instructions to transmit, by the first computing device, a high efficiency multiplexed training field (HE-MTF) using the one or more spatial channel streams. the at least one processor of the one or more processors is further configured to execute the computer-executable instructions to transmit, by the first computing device, the HE-MTF using frequency division multiplexing (FDM) format. The one or more user-specific parts are user information elements (IEs) associated with the one or more first devices.

According to example embodiments of the disclosure, there may be an apparatus. The apparatus may include means for generating a high efficiency preamble in accordance with a high efficiency communication standard, the high efficiency preamble including, at least in part, one or more legacy signal fields, one or more high efficiency signal fields, and one or more channel training fields. The apparatus may further include means for causing to send the one or more channel training fields to one or more first devices. The apparatus may further include means for determining one or more spatial channel streams associated with at least one of the one or more first devices, the one or more spatial channel streams includes a first stream and a second stream. The apparatus may further include means for partitioning the at least one of the one or more high efficiency signal fields into, at least in part, a common part and one or more user-specific parts, the one or more user-specific parts include a first user-specific part and a second user-specific part. The apparatus may further include means for causing to send at least one of the one or more user-specific parts using the one or more spatial channel streams.

Implementations may include one or more of the following features. The one or more high efficiency signal fields may include at least one of a high efficiency signal A (HE-SIG-A) field and a high efficiency signal B (HE-SIG-B) field. The first user-specific part is sent using the first stream and the second user-specific part is sent using the second stream. The apparatus may further include means for determining one or more multi-user training fields (HE-MTF) associated with the one or more channel training fields. The at least one of the one or more first devices are operating in multi-user multi-input and multi-output (MU-MIMO) wireless communication. The apparatus may further include means for transmitting, by the first computing device, a high efficiency multiplexed training field (HE-MTF) using the one or more spatial channel streams. The apparatus may further include means for transmitting, by the first computing device, the HE-MTF using frequency division multiplexing (FDM) format. The one or more user-specific parts are user information elements (IEs) associated with the one or more first devices.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
generate a high efficiency preamble in accordance with a high efficiency communication standard, the high efficiency preamble including, at least in part, one or more legacy signal fields, one or more high efficiency signal fields, and one or more channel training fields;
cause to send the one or more channel training fields to one or more first devices;
determine one or more spatial channel streams associated with at least one of the one or more first devices, the one or more spatial channel streams includes a first stream and a second stream;
partition the at least one of the one or more high efficiency signal fields into, at least in part, a common part and one or more user-specific parts, the one or more user-specific parts includes a first user-specific part and a second user-specific part; and
cause to send at least one of the one or more user-specific parts using the one or more spatial channel streams.

2. The device of claim 1, wherein the one or more high efficiency signal fields include at least one of a high efficiency signal A (HE-SIG-A) field and a high efficiency signal B (HE-SIG-B) field.

3. The device of claim 1, wherein the first user-specific part is sent using the first stream and the second user-specific part is sent using the second stream.

4. The device of claim 1, wherein the at least one processor of the one or more processors is further configured to execute the computer-executable instructions to determine one or more multi-user training fields (HE-MTF) associated with the one or more channel training fields.

5. The device of claim 1, wherein the device is an access point operating in multi-user multi-input and multi-output (MU-MIMO) wireless communication.

6. The device of claim 1, wherein the at least one processor of the one or more processors is further configured to execute the computer-executable instructions to transmit, by the first computing device, a high efficiency multiplexed training field (HE-MTF) using the one or more spatial channel streams.

7. The device of claim 1, wherein the at least one processor of the one or more processors is further configured to execute the computer-executable instructions to transmit, by the first computing device, the HE-MTF using frequency division multiplexing (FDM) format.

8. The device of claim 1, further comprising a transceiver configured to transmit and receive wireless signals.

9. The device of claim 8, further comprising one or more antennas coupled to the transceiver.

10. A non-transitory computer-readable medium storing computer-executable instructions which when executed by one or more processors result in performing operations comprising:
generating a high efficiency preamble in accordance with a high efficiency communication standard, the high efficiency preamble including, at least in part, one or more legacy signal fields, one or more high efficiency signal fields, and one or more channel training fields;
causing to send the one or more channel training fields to one or more first devices;
determining one or more spatial channel streams associated with at least one of the one or more first devices, the one or more spatial channel streams includes a first stream and a second stream;
partitioning the at least one of the one or more high efficiency signal fields into, at least in part, a common part and one or more user-specific parts, the one or more user-specific parts include a first user-specific part and a second user-specific part; and
causing to send at least one of the one or more user-specific parts using the one or more spatial channel streams.

11. The non-transitory computer-readable medium of claim 10, wherein the one or more high efficiency signal fields include at least one of a high efficiency signal A (HE-SIG-A) field and a high efficiency signal B (HE-SIG-B) field.

12. The non-transitory computer-readable medium of claim 10, wherein the first user-specific part is sent using the first stream and the second user-specific part is sent using the second stream.

13. The non-transitory computer-readable medium of claim 10, wherein the at least one processor of the one or more processors is further configured to execute the computer-executable instructions to determine one or more multi-user training fields (HE-MTF) associated with the one or more channel training fields.

14. The non-transitory computer-readable medium of claim 10, wherein the at least one of the one or more first devices are operating in multi-user multi-input and multi-output (MU-MIMO) wireless communication.

15. The non-transitory computer-readable medium of claim 10, wherein the at least one processor of the one or more processors is further configured to execute the computer-executable instructions to transmit, by the first computing device, a high efficiency multiplexed training field (HE-MTF) using the one or more spatial channel streams.

16. The non-transitory computer-readable medium of claim 10, wherein the at least one processor of the one or more processors is further configured to execute the computer-executable instructions to transmit, by the first computing device, the HE-MTF using frequency division multiplexing (FDM) format.

17. The non-transitory computer-readable medium of claim 10, wherein the one or more user-specific parts are user information elements (IEs) associated with the one or more first devices.

18. A method comprising:
generating a high efficiency preamble in accordance with a high efficiency communication standard, the high efficiency preamble including, at least in part, one or more legacy signal fields, one or more high efficiency signal fields, and one or more channel training fields;
causing to send the one or more channel training fields to one or more first devices;
determining one or more spatial channel streams associated with at least one of the one or more first devices, the one or more spatial channel streams includes a first stream and a second stream;
partitioning the at least one of the one or more high efficiency signal fields into, at least in part, a common part and one or more user-specific parts, the one or more user-specific parts include a first user-specific part and a second user-specific part; and
causing to send at least one of the one or more user-specific parts using the one or more spatial channel streams.

19. The method of claim 18, wherein the one or more high efficiency signal fields include at least one of a high efficiency signal A (HE-SIG-A) field and a high efficiency signal B (HE-SIG-B) field.

20. The method of claim 18, wherein the first user-specific part is sent using the first stream and the second user-specific part is sent using the second stream.
